(19) United States
(12) Patent Application Publication
(10) Pub. No.: US 2002/0174757 A1
(43) Pub. Date: Nov. 28, 2002

(54) Wire saw

(75) Inventor: Stu Mackie, Whittier, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gryphon Corporation, Sylmar, CA (US)

(21) Appl. No.: 10/066,177

(22) Filed: Jan. 30, 2002

Related U.S. Application Data
(60) Provisional application No. 60/265,569, filed on Jan. 31, 2001.

(51) Int. Cl. B26D 5/08; B26D 1/00

(52) U.S. Cl. 83/651; 83/651.1; 83/523

(57) ABSTRACT

A saw arrangement that includes two elongated guides and a blade chuck including two guide receptacles that cooperate with the elongated guides. A blade is coupled to the blade chuck and a rotary motor including a drive block and an arm coupled to the blade chuck and the drive block drive the blade during use of the saw arrangement. The blade is generally a circular blade shaped as a wire, thereby allowing for inside cuts on a work piece to be performed.

### CROSS-REFERENCES TO RELATED APPLICATIONS

This application claims priority to U.S. Provisional Application No. 60/265,569 (Attorney Docket No. 016676-000300US) filed Jan. 31, 2001 which is herein incorporated by reference for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

1. Field of the Invention

The present invention relates to a saw arrangement, and more particularly, to a high-speed saw arrangement suitable for cutting hard materials.

2. Description of the Prior Art

It is often desirable to cut very hard materials such as, for example, glass or rock. However this is generally difficult since it is fairly noisy to cut these types of materials. Furthermore, when cutting such materials, large amounts of heat are produced.

Another problem in cutting very hard materials, and indeed, other types of materials, is to maneuver a saw blade in order to do inside cuts. With most current saw arrangements, it is virtually impossible to do inside cuts.

### SUMMARY OF THE INVENTION

The present invention provides a saw arrangement that includes two elongated guides and a blade chuck that includes two guide receptacles that cooperate with the elongated guides. A blade is coupled to the blade chuck and a drive is coupled to the blade chuck in order to move the blade chuck along the elongated guides, thereby driving the blade.

In accordance with one aspect of the present invention, the drive includes a rotary motor including a drive block and an arm coupled to the blade chuck and the drive block.

In accordance with another aspect of the present invention, the saw arrangement further includes a saw chassis and a housing for the drive, wherein the drive is isolated from the saw chassis with isolation grommets and a bumper.

In accordance with yet another aspect of the present invention, the elongate guides comprise steel dowels.

In accordance with a aspect of the present invention, the saw arrangement includes a circular blade shaped as a wire.

In accordance with a further aspect of the present invention, the saw arrangement includes a cover that covers the guides, the blade chuck, the drive block and the arm. A light is coupled to the cover.

In accordance with another aspect of the present invention, the saw arrangement includes a coolant supply.

Other features and advantages of the present invention will be understood upon reading and understanding the detailed description of the preferred exemplary embodiments founds hereinbelow, in conjunction with reference to the drawings, in which like numerals represent like elements.

### BRIEF DESCRIPTION OF THE DRAWINGS

FIG. 1 is a perspective view of a saw arrangement in accordance with the present invention;

FIG. 2 is a front elevation view of a portion of the saw arrangement illustrated in FIG. 1 with the cover removed;

FIG. 3 is a right side elevation view of the saw arrangement illustrated in FIG. 1;

FIG. 4 is a left side elevation view of the saw arrangement illustrated in FIG. 1; and

FIG. 5 is an example of a blade guide for use with a saw arrangement in accordance with the present invention.

### DESCRIPTION OF SPECIFIC EXEMPLARY EMBODIMENTS

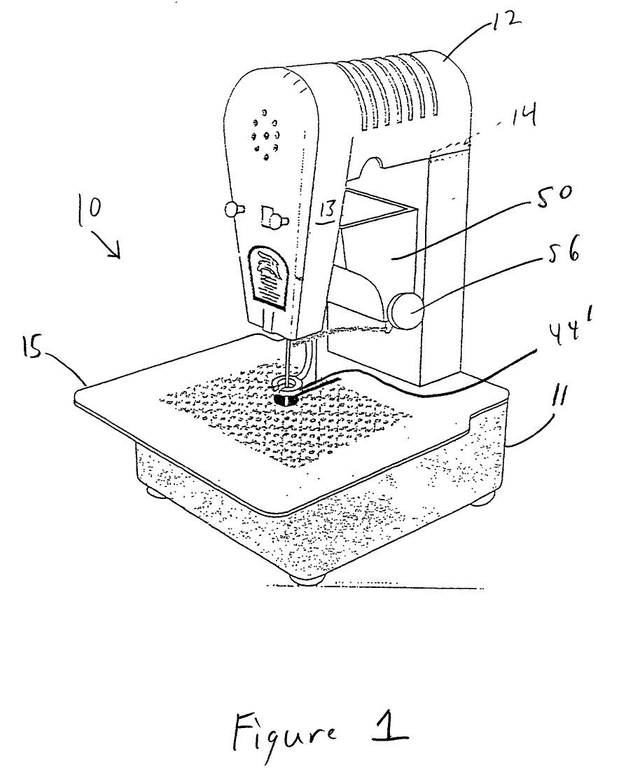

FIG. 1 illustrates a saw arrangement 10 including a base 11, a motor housing 12, a saw chassis 13, a bumper 14 and a platform 15. Preferably the motor is a 4200 rpm rotary motor. Such a motor supplies approximately 8400 strokes per minute, which is adequate for cutting glass with a diamond blade.

As can be seen in FIG. 2, a drive block 20 is coupled to an arm 21, which in turn is coupled to a blade chuck 22. The blade chuck preferably includes two opposing guide receptacles 23, 24 that cooperate with two elongated chuck guides 25, 26. Preferably, the guides are steel dowel pins, which also serve as heat sinks during operation of the saw.

The arm is preferably coupled to the drive block with a wrist pin 30. Likewise, the arm is preferably coupled to the blade chuck with a wrist pin 31. An upper blade guide 32 is provided, preferably in the form of an aluminum block, to which the two elongated chuck guides are coupled. A hole 33 is defined in the blade guide to allow for passage of a saw blade 34 therethrough.

The blade chuck includes a receptacle 40 for receiving the saw blade. Preferably, a nut 41 is provided that upon tightening holds the saw blade in the blade chuck. preferably provided for the round, wire blade and is mounted in the base. The lower blade guide preferably comprises self-lubricating plastic with a hole 43 defined therein for receiving the blade. An example of a blade guide is illustrated in FIG. 5. The lower end of the round blade is placed in lower guide hole 43 and rides therein during use of the saw. The lower blade guide helps keep the blade straight during use. Preferably an upper secondary blade guide 44 is provided that is similar to the lower blade guide. Another example of a blade guide 44′ may be seen in FIG. 1.

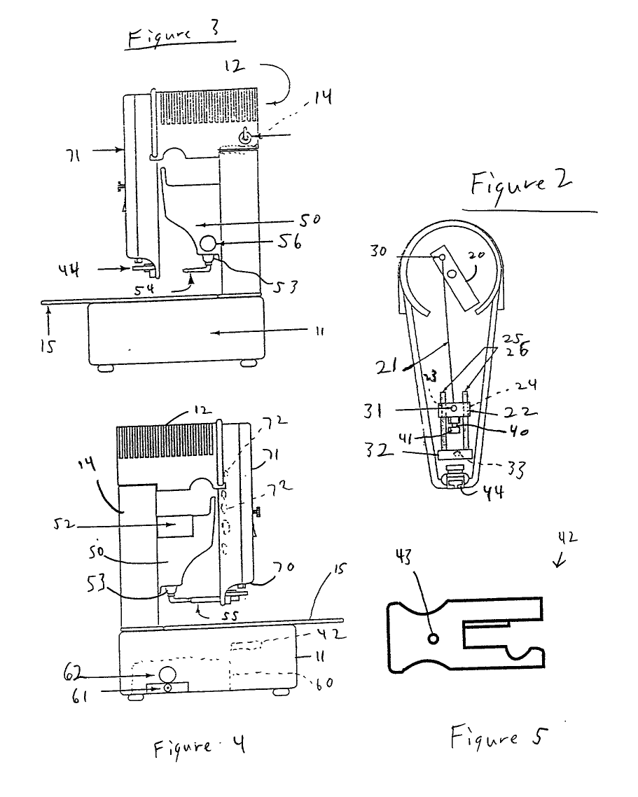

With references to FIGS. 3 and 4, a water or coolant supply system that is preferably provided with the saw arrangement may be explained. A reservoir 50 is provided for holding the water or coolant supply. A fill spout 52 is provided near the top of the reservoir and an outlet 53 is provided near the bottom. Preferably the outlet includes a barbed fitting 54 for attachment of a feed tube 55 thereto. The feed tube may then supply water or coolant to the saw blade. A valve 56 is used to control the supplying of coolant to the blade.

A used water or coolant reservoir 60 is provided in the base. Preferably a barbed fitting 61 is provided for connecting a drainage tube thereto (not shown). A valve 62 is used to open and close the drain fitting to allow for removal of the used water or coolant.

Preferably, a light 70 is provided under a front cover 71 to light the platform and work area of the saw.

Additionally, preferably the motor is mounted within the housing by a series of vibration dampening grommets 72 between reservoir 50 and cover 71. This helps keep the operating noise to a reasonable level and reduces the vibration of the saw by isolating the saw chassis from the drive system. Furthermore, bumper 14 helps in dampening the operating the noise.

In operation, the rotary motor turns the drive block, which in turn causes the arm to move up and down, thereby moving the blade chuck up and down along the elongated guides. This in turn causes the blade to move up and down against the work piece thereby cutting the work piece. Additionally, by using the round, wire blade, inside cuts on the work piece are possible. The coolant helps keep the blade and the work piece from overheating. Likewise, as previously mentioned, the steel dowel pins serve as additional heat sinks.

Although the invention has been described with reference to specific exemplary embodiments, it will be appreciated that is intended to cover all modifications and equivalents within the scope of the appended claims.

What is claimed is:

1. A saw arrangement comprising:
two elongated guides;
a blade chuck including two guide receptacles that cooperate with the elongated guides; and
a drive coupled to the blade chuck to move the blade chuck along the elongated guides.

2. A saw arrangement in accordance with claim 1 wherein the drive comprises a rotary motor and an arm coupled to the blade chuck.

3. A saw arrangement in accordance with claim 2 further comprising a saw chassis and a housing for the drive, wherein the drive is isolated from the saw chassis with isolation grommets and a bumper.

4. A saw arrangement in accordance with claim 1 wherein the elongated guides comprise steel dowels.

5. A saw arrangement in accordance with claim 1 further comprising a circular blade shaped as a wire and coupled to the blade chuck.

6. A saw arrangement in accordance with claim 2 further comprising a cover covering the guides, the blade chuck, the drive block and the arm, the cover including a light coupled thereto.

7. A saw arrangement in accordance with claim 5 further comprising a coolant supply.
